(19) United States
(12) Patent Application Publication
(10) Pub. No.: US 2011/0305804 A1
(43) Pub. Date: Dec. 15, 2011

(54) BEVERAGES HAVING REDUCED TURBIDITY AND METHODS FOR MAKING SAME

(76) Inventors: Gino Olcese, Allen, TX (US); Witold Rossochacki, McKinney, TX (US); Jeff Allard, McKinney, TX (US); Arturo Martinez, Plano, TX (US)

(21) Appl. No.: 12/797,458

(22) Filed: Jun. 9, 2010

(51) Int. Cl. A23L 2/70; A23L 2/72; A23L 2/02

(52) U.S. Cl. 426/324; 426/590; 426/599

(57) ABSTRACT

Methods of producing a clarified beverage may involve combining a first beverage component having one or more proteins with a second beverage component having one or more polyphenols. At least one of those components may be treated with one or more fining agents prior to combination. The addition of the second beverage component may be performed in a step-wise manner. Particles may be filtered from the beverage prior to packaging. Clarified beverages may be produced according to these methods.

### FIELD

The present disclosure relates to methods of stabilizing a beverage, methods of improving the shelf life of beverages, and beverages produced using such methods.

### BACKGROUND

For a majority of beverages, there is an expectation that those beverages maintain some level of clarity. Products that do not maintain clarity may be viewed less favorably by consumers or may be interpreted to be defective. Solid material that separates from a liquid is one of many possible consequences of haze formation and may in some cases produce a beverage that has a clumpy and/or murky appearance. The control of beverage haze is therefore an important concern during production and storage of a beverage. When combining beverage components, materials within those components may interact to initiate the formation of particulate matter, and such particles may scatter light, initiate haze, and cause a loss of clarity.

Among causes of haze formation in beverages are the growth of various crystals, such as from oxalates or tartrate salts, biological material, or other contaminants, and the formation of protein clusters that may result from the interaction of some proteins and polyphenols. Some of the above causes may be readily controlled using established techniques and quality control procedures; however, haze formation due to the interaction of protein and polyphenols can be problematic. For some beverages, stabilization may be achieved by removing the proteins that may cause particle growth. However, the removal of those proteins may be difficult to achieve, and the widespread removal of proteins may result in inadvertent removal of a number of beneficial species that may be desired in the final beverage. Therefore, there is a need for methods that more efficiently remove materials that cause haze and which allow the production of stabilized beverages.

### SUMMARY

Methods of producing clarified beverages that are resistant to the formation of particles that may cause haze are described. Those methods may involve the combination of two or more beverage components that may contain proteins, polyphenols, or a combination of both. In some embodiments, at least one of those components is treated with one or more fining agents prior to combination. The addition of one or more fining agents may remove at least some proteins from a beverage component, and such removal of proteins may enable the production of a stabilized beverage following the addition of that component to other beverage ingredients.

In some embodiments of methods of producing a beverage, two or more components may be added in a step-wise manner, and that step-wise addition may be tailored to produce a first concentration ratio of protein and polyphenol and a second concentration ratio of protein and polyphenol. That step-wise addition may facilitate the formation of haze prior to filtration and final packaging of a beverage. That haze may include particles with size distributions that may be relatively large, and those particles may be effectively removed from solution by passing those particles through a filter.

In some embodiments of methods of producing a beverage, conditions including pH, concentration, temperature, or any combination of conditions thereof may be selected to modify the form of polyphenols in at least a portion of a first latent stage of haze formation occurring in a beverage during some stage of production of that beverage. In some embodiments of methods of producing a beverage, one or more components that are rich in polyphenols may be heated prior to combination with one or more protein-rich components. That heating stage may decrease the time lag between mixing and haze formation and may be executed prior to at least one stage of filtration before final packaging of a beverage.

### BRIEF DESCRIPTION OF THE FIGURES

FIG. 1 is a graph showing the concentration dependence of the formation of haze for a model protein (gliadin) and a model polyphenol (tannic acid).

FIG. 2 is a flowchart showing a method of producing a beverage.

FIG. 3 is a flowchart showing a further method of producing a beverage.

FIG. 4 is a flowchart showing a method of combining components that may be used in a beverage.

### DETAILED DESCRIPTION

The following terms as used herein should be understood to have the indicated meanings.

When an item is introduced by “a” or “an,” it should be understood to mean one or more of that item.

The term “beverage” as used herein means any drinkable liquid or semi-liquid, including for example flavored water, soft drinks, fruit drinks, coffee-based drinks, tea-based drinks, juice-based drinks, milk-based drinks, gel drinks, carbonated or non-carbonated drinks, alcoholic or non-alcoholic drinks.

The term “cluster” as used herein means a combination of any number of units greater than two.

“Comprises” means includes but is not limited to.

“Comprising” means including but not limited to.

The term “fining agent” as used herein means any material that may be added to a beverage or beverage component that facilitates the removal of a species that is present in solution. Fining agents may include by way of example and without limitation bentonite, silica gel, egg white, polyvinylpolypyrolidone, carbonaceous material, gum arabic, kieselsol, isinglass, yeast, alginate, casein, gelatin, or chitin.

The term “fruit juice” as used herein means a liquid that may be produced from fruit matter, including for example apple, grape, strawberry, grapefruit, kiwi, pear, and orange, or any combination thereof.

“Having” means including but not limited to.

The term “mixing” as used herein means any process that enables two or more species in a solution to become more evenly distributed. Mixing may include by way of nonlimiting example active methods or passive methods such as diffusion.

The term “tank” as used herein means a container that may hold a liquid.

The term “stabilization” as used herein means any process that decreases the rate of change of transparency or minimizes the scattering of visible light of a beverage that is intended to be clear and has been packaged for consumption by a consumer.

The term “vegetable juice” as used herein means a liquid that may be produced from vegetable matter, including for example carrot, cucumber, beets, pumpkins, tomatoes, celery, turnip, or any combination thereof.

This disclosure is directed to methods of stabilizing a beverage, methods of improving the shelf life of beverages, and to beverages produced using those methods. Beverages available for sale and consumption by consumers are expected to have various characteristics during their lifetime. Included among those characteristics is, at least for a majority of beverages, an expectation of a level of clarity. The clarity of a beverage is related to the level of transparency of a solution. Clarity may be affected by the presence of suspended particle matter which may scatter light, result in the presence of haze, and increase a solution's turbidity. The suspension of particulate matter in solution and its effect on beverage clarity is one of a number of detrimental characteristics that may limit the lifetime of a beverage. Stabilization of a beverage may increase the lifetime of a beverage by helping maintain its appearance in a state that is expected by a consumer.

The methods described herein may involve stabilization by removing one or more species from a beverage or from one or more components of the beverage that may be combined in one or more stages of beverage production. Those species may, if not removed, modify the formation of particulate matter and in some embodiments may be proteins, polyphenols, or other molecules. Some polyphenols may, for example, facilitate the combination or aggregation of proteins into more massive structures, including into particles of sizes that are sufficient to scatter light, raise the turbidity of a solution, and cause beverage haze. In some embodiments, the removal of materials may be selective, involving the removal of certain species without the inadvertent removal of other species found in a beverage. The selective removal of proteins that initiate haze may, for example and in some embodiments, be involved in the production of beverages that are rich in proteins, rich in polyphenols, and also resistant to the formation of haze. Methods described herein may prevent or change the rate of formation of particulate matter, such as by increasing or decreasing the rate of formation of particulate matter, in one or more stages of beverage production. Some embodiments may decrease the rate of formation of particulate matter by removing proteins, polyphenols, or a combination of both that if present may interact to form particulate matter. Some embodiments may increase the rate of formation of particulate matter during at least some stages of production, and may promote the production of particulate matter that has a particle size distribution which is amenable to further processing. For example, production of a particle size distribution that is relatively large may enable the effective removal of haze-forming substances without substantial removal of other substances. The removal of species during production may have a large effect on the stability of the final beverage after it is packaged for sale and consumption. Methods of stabilizing a beverage may improve the lifetime of a filtration system useful for the production of a beverage, including for example by allowing the use of filters with a larger average opening size, that size being compatible with the size of particles that are intended for removal. Some methods of stabilizing a beverage may include both a vegetable component and a fruit component and may, in addition to producing a beverage that is resistant to haze and which has a long product shelf life, control the concentration of proteins, polyphenols and other molecules to improve beverage taste, nutritive value, or both.

Particulate matter may be removed from a liquid solution in various ways, including but not limited to passing a liquid that contains particulate matter through a filter. Particulate matter may be removed from solution by allowing it to settle, such as by gravity or by some other mechanism, along a surface of a tank. That surface may be modified in some way to collect particulate matter and may, for example, include addition of a porous structure or some other structure that traps particulate matter. Other mechanisms of removing particulate matter from a liquid solution may include but are not limited to cooling a solution, using the application of a centrifugal force, or using other removal methods as known in the art.

Removing particulate matter from a beverage may result in the inadvertent removal of materials that contribute positive attributes of a beverage. Such a problem may be particularly important for particulate matter with a large protein content as such material may be aggregated with a wide range of different species. Species may be associated with particulate matter through specific or nonspecific binding and may be associated by either covalent or noncovalent interactions. In general, when a large amount of particulate matter is removed from a beverage or when it is difficult to remove that particulate matter from other materials, it will be difficult to control the inadvertent loss of material. Therefore, included among techniques to minimize the risk of inadvertent species being removed from a beverage are minimization of the amount of particulate matter that is formed, the formation of particulate matter of a size or consistency that makes it easy to filter or remove, or a combination thereof.

Material that may be inadvertently removed from a beverage include without limitation polyphenols, antioxidant molecules, proteins, minerals, vitamins, or any combination thereof. Such material may be desired in the final beverage for any number of reasons including for example that such material may improve a beverage's mouthfeel, flavor, color, or appearance or provide other benefits. In some embodiments, the concentration or the distribution of polyphenols that are removed from a beverage may be controlled such as to produce a final beverage that is rich in antioxidants and also has a controlled level of astringency.

In some embodiments, measurements related to a solution's turbidity may be made during at least some stage of production. Measurements related to turbidity may involve techniques including but not limited to those based on the detection of light. Light may be derived from an optical source and may be measured using one or more optical detectors. Such detectors may be placed at any of various angles from the optical source, and data derived from such detectors may be used to measure or estimate light transmission, light scattering, or a combination of both. Scattered and transmitted light may be collected concurrently or at different times. In some embodiments, a beverage or component material used in the production of a beverage may be stirred before a measurement related to solution turbidity is taken. Data may be collected as a function of time, following some time point, which may be for example a time point marked by the cessation of stirring of a beverage. Measurements may in some embodiments involve the growth or decay of an optical signal as a function of time. During the time period of measurements, particulate material may for example settle from a liquid and thereby may not intersect with the interrogating light. Optical measurements may involve substantially monochromatic, polychromatic, or any acceptable wavelength range of electromagnetic energy. In some embodiments, data may be taken at various time points during a process and may, for example, depending on the amount or average particle size of suspended matter, take measurements of light transmission, light scattering, or both.

In some embodiments, components useful in production of beverages may include one or more of a fruit juice, vegetable juice, a liquid with polyphenols, a liquid that is a protein-rich source, or any combination thereof. As described above, proteins and polyphenols may be associated with the formation or growth of particulate matter, and stabilization of a beverage may in some embodiments involve removal or control of proteins, polyphenols, or a combination of either. Removal of those species may be useful in control of haze formation in various beverages, including by way of nonlimiting example beers, wines, teas, fruit juices, vegetable juices, sports beverages, or combinations thereof. Proteins that interact with polyphenols have been studied, and it has been identified that such proteins may contain a high proportion of the amino acid proline. In beer, for example, a class of proteins that may be derived from barley, the prolamines, which are commonly referred to as hordein proteins, have been identified and have been shown to be associated with haze formation. The barley prolamines are proline-rich and represent a relatively low fraction of proteins in beer. In juices, proteins that interact with polyphenols have also been studied, and such proteins are similarly known to contain a relatively high proportion of proline. In many cases, those proteins that cause haze constitute a limited fraction of the total protein content in a material. This may be important in some beverages that include proteins or other substances that may provide beneficial properties. For example, such proteins may improve the taste, nutritive value, color, or modify other properties of a beverage in a beneficial way. In those circumstances, it may be useful to selectively remove those proteins that cause haze formation without removing a substantial fraction of other proteins or other substances from a material. In other circumstances, beverages may be made where the protein content of a beverage is not as critical. In those situations, it may be possible to remove proteins using relatively non-selective techniques, and some of those techniques may be advantageous in that they may be particularly amenable for rapid, low-cost processing of foodstuffs.

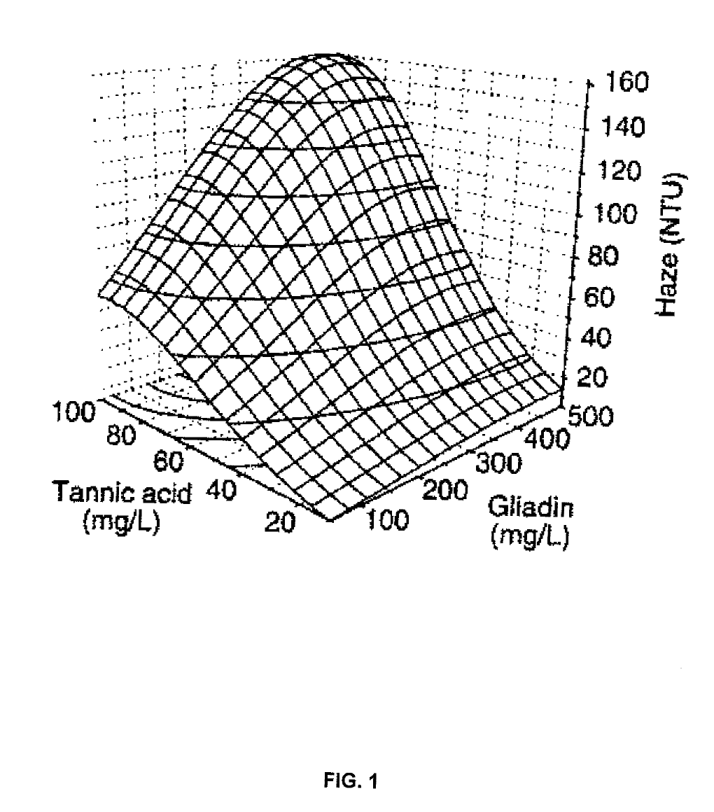

When certain proteins are allowed to contact certain polyphenols in a liquid solution, those polyphenols or reaction products of those polyphenols that may form in solution, may interact with sites on one protein and with other sites on another protein and thereby initiate the combination of more than one protein into a protein cluster. The polyphenols of interest for such an interaction include those that have two or more hydroxyl groups on two or more aromatic rings and include (+)-catechin, (−)-epicatechin, and other polyphenols including proanthocyanidins. At least some of those polyphenols may exist or are known to form under certain conditions in various juices, beers, teas and wines. Interactions of proteins and polyphenols and the concentration dependence of that interaction have been studied by K. Siebert. See K. Siebert, Effects of Protein-Polyphenol Interactions on Beverage Haze, Stabilization, and Analysis, J. Agric. and Food Chem. vol. 47 no. 2, 1999 pp. 353-362. As described by Siebert, when the concentration of polyphenol added to a protein in a protein and polyphenol mixture is low, most of the interaction sites within a protein will be unoccupied, and the probability of forming combinations of proteins of large particle size is low. As the concentration of polyphenols increases in a protein and polyphenol mixture, the probability of protein combinations connected through interaction with polyphenols is, at least in some concentration regimes, enhanced. If the concentration of polyphenols in a mixture is increased further, there is an increased probability that an interaction site on a protein will be associated with a polyphenol; however, the probability that a polyphenol interacting with a protein will find another protein in solution that is not occupied by a polyphenol may be low. In that circumstance, smaller particles may form, and low beverage haze may result. A general response function describing the concentration relationship between an example protein and an example polyphenol is shown in FIG. 1, which was previously published in the above cited article by K. Siebert. In FIG. 1, tannic acid is a model polyphenol, and gliadin is a model protein that is known to contribute to haze and that contains a relatively high proportion of proline residues. As shown in FIG. 1, haze formed in a beverage is dependent upon the concentration of protein and dependent upon the ratio of protein and polyphenol. In some embodiments, two or more components may be added in a step-wise manner, and that step-wise addition may be tailored to produce a first concentration ratio of protein and polyphenol and a second concentration ratio of protein and polyphenol as described herein. The formation of haze in a beverage has been shown to follow at least a two-stage growth pattern. See K. Siebert, supra. In a first latent stage, little increase in haze may be evident, and following this first latent stage a second active stage may proceed where a steady rise in haze may occur. In some embodiments, conditions including pH, concentration, temperature, or any combination thereof may be selected to modify the form of polyphenols in at least a portion of a first latent stage of haze formation occurring in a beverage during some stage of production of that beverage.

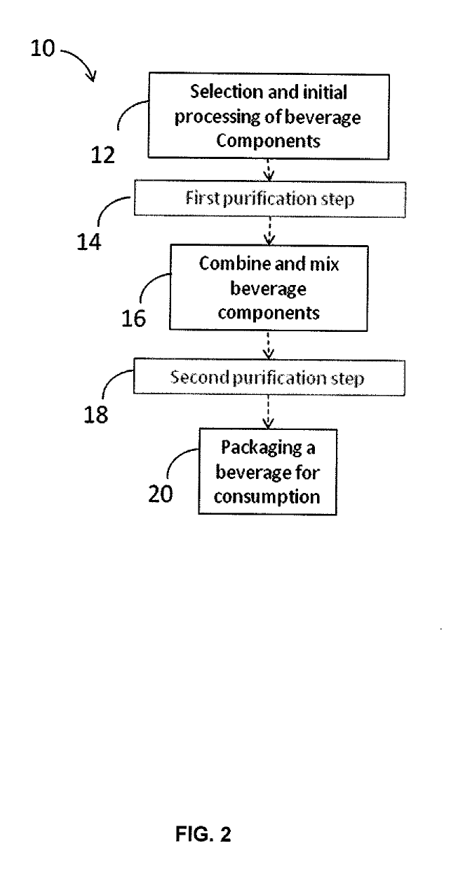

Referring to FIG. 2 of the drawings, the reference numeral 10 generally designates improved methods of producing a beverage. Those methods comprise a selection and processing of beverage components at step 12, a first purification step 14, combining and mixing the components at step 16, a second purification step 18, and packaging a beverage for consumption at step 20.

Various components may be selected for a beverage in step 12, including one or more components that may include proteins, at least some of which are capable of interacting with polyphenols to fou xi particulate matter. In some embodiments, a first component may be a material that contains a substantial proportion of proteins, and a second component may be a material that contains a lower concentration of protein or may be substantially free of proteins. It should be understood that the description of a process involving two components is made for the purpose of explanation and is not intended to be limiting. In some embodiments, a first component may be selected that is a vegetable juice, and a second component may be selected that is a fruit juice. Fruit juice and vegetable juice components may be combined in any ratio, including for example and without limitation, about ⅓ vegetable juice and about ⅔ fruit juice. For those embodiments that involve addition of a vegetable component to a fruit component, it may be the case that the protein content in the vegetable component will be higher than the protein content in the fruit component. In contrast, the polyphenol concentration of a fruit component may be higher than the polyphenol concentration of a vegetable component. The processing of components in step 12 may involve various steps associated with liquification, including but not limited to physical maceration of the components, extraction, and filtration.

Still referring to FIG. 2, a first purification step 14 may involve the removal of species such as proteins from one or more of the individual components selected for use in a beverage. In some embodiments, proteins may be removed from a vegetable juice component, and the removal of protein may be accomplished by treatment of the vegetable juice with a fining agent. In some embodiments, the fining agent may be bentonite. Bentonite is a montmorillonite clay that may be a layered structure and may expand when placed in water. Bentonite includes an aluminum silicate anionic portion and may serve to attract proteins by interaction with a cationic portion of a protein that may be present in solution. For at least that reason, the removal of proteins from a beverage component may be dependent upon pH. In some embodiments, application of a fining agent during a first purification step 14 may enable the removal of proteins from a component at a different pH than may be found in the final beverage intended for consumption. For example, the removal of proteins may be at a pH between about 4.0 and about 4.5, and the pH of the final beverage may be between about 3.0 and about 4.5. As proteins adsorb on or within bentonite, cations present within the bentontite structure, and which may be any of a range of different ions, may enter into solution, such as to compensate for the solution electrostatic charge. Bentonite that is rich in any of various cations, including by way of nonlimiting example sodium, potassium, calcium, or any combination thereof, may be used in some embodiments of methods of producing a beverage. Bentonite may be added to a beverage component as a slurry and may be mixed with water, mixed with a beverage component, or diluted in an appropriate manner prior to addition. Bentonite may alternatively be added as a solid. In some embodiments, bentonite may be added at levels of between about 0.1 gm/l to about 5.0 gm/l. In other embodiments, bentonite may be added at levels between about 0.5 gm/l to about 2.8 gm/l. Bentonite that may be added in a first purification step 14 may be removed after interaction with proteins in solution in various ways, such as by allowing bentonite particles to fall from solution or using other approaches.

In some embodiments, the first purification step 14 may use a fining agent that is selective for removing a specific type of protein from other proteins that may be present. Silica gel is one fining agent that may be used to selectively remove proteins, including some that may be proline-rich and may interact with polyphenols to cause haze from other proteins in solution. Polyvinylpolypyrolidone is a fining agent that is thought to bind polyphenols. As described previously, polyphenols may be bound to proteins, and when those polyphenols contain at least two separate regions that may bind to a protein, one of those regions may be bound to a first protein and another region may be bound to a second protein. In some cases, including for example and without limitation when the polyphenol level in solution is higher than the level of proline-rich proteins capable of initiating haze a portion of those proline rich proteins will be bound to only one of the separate regions of a polyphenol that are capable of binding to a protein. Other regions of the polyphenol may be free to bind with other compatible materials, and those may include polyvinylpyrolidone. That polyvinylpyrolidone may also be used to remove both polyphenol to which it binds and the protein that is connected to that polyphenol. In some embodiments, a combination of bentonite and one or more other fining agents that are selective for removing a certain type of protein from other proteins that may be present in solution may be used. The collection of fining agents that are used may selectively remove proteins of more than one type and may control those levels for a specific application, including for example and without limitation applications that demand the control of both the total protein content in a mixture and the proportion of proteins that are capable of binding polyphenols.

Control of the level of proteins that bind polyphenols may in some embodiments be used to modify the concentration of polyphenols that are and are not bound to a protein in a beverage. The concentration of polyphenols that have at least one free end in solution may play various roles in modifying the taste of a beverage. By way of nonlimiting example, polyphenols may interact with salivary proteins in the mouth of a consumer upon consumption, and that interaction may initiate the precipitation of those salivary proteins. The precipitation of those salivary proteins may result in a beverage having the taste attribute of astringency. In that light, some embodiments of methods 10 of producing beverages may use one or more fining agents to control the concentration of total protein and the concentration of proteins capable of interacting with polyphenols. Those beverages may have both an acceptable shelf life and also provide a beverage that has some free proteins capable of binding with certain polyphenols, which are capable of interacting with salivary proteins, which may be present or may form in solution during storage. The level of proteins that bind those polyphenols may in some embodiments be used to control the astringency of a beverage or the rate of change of astringency over an extended period. In some embodiments, the rate of change of astringency during the shelf life of a beverage may be controlled by modifying the amount of total protein removed and the amount of protein capable of binding polyphenols in a first purification step 14. Those beverages may show very little change in astringency during beverage lifetime.

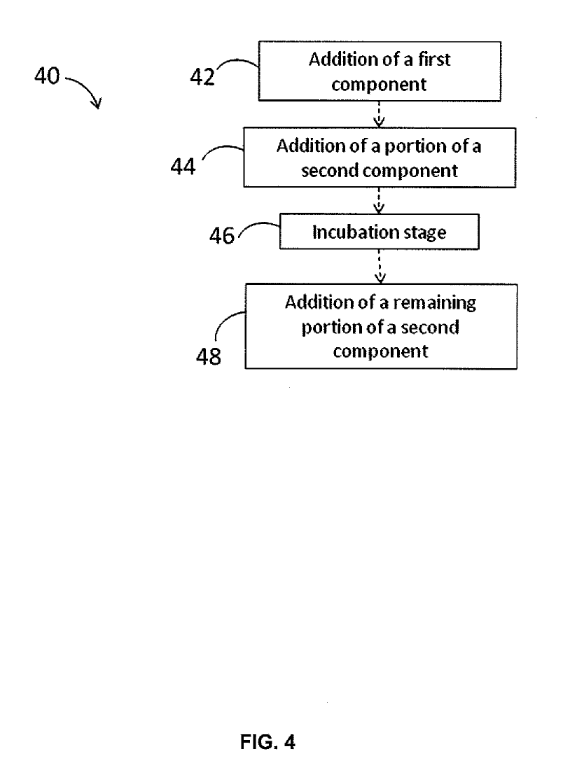

Still referring to FIG. 2, methods 10 may involve combining and mixing beverage components at step 16. That combination may involve addition of the components in any order and may involve the addition of components such that after the addition they are near the desired concentration of those components in a final beverage. Other embodiments that involve the addition of reagents in a step-wise manner are also described herein, including in reference to FIG. 4. In step 18, further purification of the beverage may be performed. As described previously, some embodiments may involve the combination of a vegetable juice that includes substantial amounts of protein and a fruit juice that includes much less protein. The vegetable juice component may be subjected to a first purification step 14, such as by treatment with a fining agent including for example bentonite, and in some embodiments that first purification step may be sufficient to remove at least a substantial amount of protein to stabilize a beverage. In those situations, the amount of particulate matter that is formed after the combination of a vegetable juice component and a fruit juice component may be much lower than would be formed if the first purification step was omitted. This may be important for several reasons, including that the amount of particulate matter which remains or may form in the beverage will be less than otherwise, and only a small amount of matter, if any, will have to be removed. The fruit component may contain a large amount of polyphenols, other antioxidants, vitamins, or minerals, and at least some of those species may be subject to inadvertent removal in a manner dependent upon the mass of matter that is removed. In that light, minimizing the amount of particulate matter that is foiuied after the combination of a vegetable component and a fruit component may enable the production of a beverage that has improved characteristics, including by way of nonlimiting example nutritional value or taste. For example, some other techniques described for comparison purposes may involve stabilization of the combined beverage only. In those other techniques, the amount of material that may be inadvertently removed after combination of various beverage components may be greater than in the improved techniques described herein. It is noted that in general consumers prefer the taste of fruit juice to that of vegetable juice, and the risk of taste loss due to inadvertent removal of material is greater if matter derived from fruit is removed. In that light, some embodiments that involve a first purification step that includes substantial protein removal from a vegetable component prior to its combination with a fruit component may be useful for creating a stabilized beverage with improved taste characteristics.

The second purification step 18 as described in FIG. 2 may include the removal of particles by gravity filtration, may involve passing the solution through a filter to collect residual particles, or a combination of those operations. As described above, the total amount of material that is removed in second purification step 18 may be decreased because protein has been removed previously from one or more beverage components in a first purification step 14, including by way of nonlimiting example treatment of a vegetable component with a fining agent such as bentonite. In some embodiments, second purification step 18 may be unnecessary and such may be the case for example in those beverages derived from components that are sufficiently stabilized as a result of first purification step 14. In a next step 20, the stabilized beverage may be packaged and shipped for consumption. In some embodiments, that packaging and shipping for consumption step 20 may involve heating of a beverage.

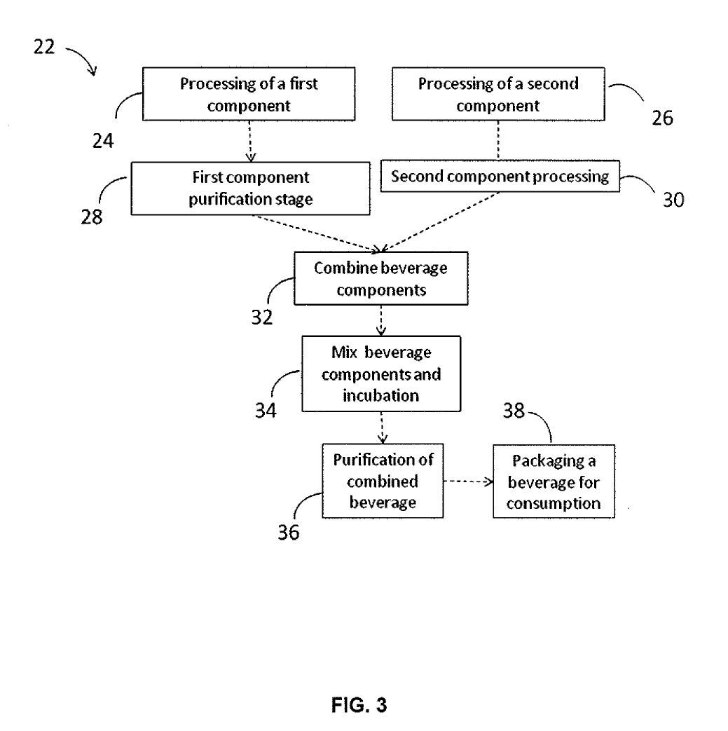

Referring to FIG. 3 of the drawings, the reference numeral 22 generally designates an improved method of producing a beverage. Like the general methods described in relation to FIG. 2, the description of two beverage components is illustrated for simplicity and should not be interpreted to be limiting. Like some embodiments described in reference to FIG. 2, methods described in relation to FIG. 3 may be useful in production of a stabilized beverage that has improved characteristics including but not limited to taste, shelf life, and nutritive value. Various components may be selected for use in a method 22 of producing a beverage. A first component processed in a step 24 may be a species that includes proteins, at least some of which are capable of interacting with polyphenols to form particulate matter. That first component may or may not include at least some level of polyphenols, and in some embodiments may be a vegetable juice. A second component processed in a step 26 may be a species that may include a lower amount of protein and a higher amount of polyphenols than the first component processed in a step 24. In some embodiments, a first component may be a vegetable juice and a second component may be a fruit juice. The processing of the first component and the second component may include steps associated with liquification of a solid, including but not limited to physical maceration, extraction, and filtration.

In a first component purification step 28, a first component may be processed with a fining agent that may remove at least some fraction of proteins from the first component. By way of nonlimiting example, fining agents that may remove protein from a first component include bentonite, silica gel, yeast, and chitin. As described further in some embodiments, it may be advantageous to avoid removing some proteins at the first component purification step 28. This may be done, for example, and as described in more detail herein, to purposefully initiate the formation of protein and polyphenol particles and enable the selective removal of some polyphenols during a filtration of combined beverage components step 36. In some embodiments, proteins may not be removed and first component purification step 28 may be omitted.

In a second component processing step 30, a second component may be processed in various ways, including but not limited to heat treatment. In some embodiments, that heat treatment may involve holding a second component in a temperature range and for a time period that decreases a first latent stage of haze formation. In some embodiments, such a heat treatment may include raising the temperature of the second component that is a fruit juice, including but not limited to apple juice or grape juice, to a temperature between about 60° C. to about 90° C. for a time period between about 20 minutes and about 120 minutes. In some embodiments, a heat treatment may be used that is between about 70° C. to about 85° C. for a time period between about 40 minutes and about 60 minutes. In some embodiments, a heat treatment may be used that is between about 45° C. to about 55° C. for a time period between about 40 minutes and about 5 hours. In some embodiments, a second component processing step 30 may involve the addition of a protein, including but not limited to gliadin, and that protein may for example be useful to bind and stabilize a polyphenol in one conformation over another. A protein added to a second component in a second component processing step 30 may be denatured by heat treatment or may be treated with an enzyme that is capable of cleaving that protein into smaller units. Such smaller units or fragments may be capable of binding a polyphenol and stabilizing it in one conformation and may also be small enough that clusters or aggregates of those fragments will not cause haze.

Still referring to FIG. 3, a method of producing a beverage may include a step 32 that involves combining the beverage components. That combination may involve addition of the components in any order and may involve the addition of components such that after the addition they are near the desired concentration of those components in a final beverage. In some embodiments, a step-wise addition may be used, and after one stage in that addition one or more components may be added at a concentration that is different from the final concentration. Following the combination of beverage components, the beverage may be mixed such as by diffusion, active stirring, or using some other mechanism and may sit at ambient temperature or some other temperature for a period of time. If active mixing processes are used, such processes may be performed at or near the beginning of mixing and incubation step 34, throughout mixing and incubation step 34, or at any interval of time during mixing and incubation step 34. In some embodiments, the incubation period may be substantially longer than the period necessary to mix the beverage components. During that time period, proteins that may be substantially derived from a first component may interact with polyphenols that may be substantially derived from a second component and may begin to form particulate matter. In some embodiments, the time at which the combined beverage components may incubate may be between about 1 hour and about 7 days. In general, the incubation period useful to cause formation of haze may be related to the conditions selected during the second component processing step 30. As previously noted, heat treatment that may be used during the second component processing step 30 may involve holding a second component in a temperature range and for a time period that decreases a first latent stage of haze formation. In some embodiments of methods 22, a second component processing stage 30 may involve a heat treatment that is above 65° C., and mixing and incubation step 34 may be less than about 2 days. In some embodiments, the time period for mixing and incubation step 34 may not be of a predetermined time interval, such as determined prior to component combination, and the completion of mixing and incubation step 34 may be monitored using diagnostic techniques, including by way of nonlimiting example the use of measurements related to turbidimetry. In some embodiments, the incubation period may be performed during the majority of its duration at a temperature that is near ambient room temperature or at some higher temperature, and then at some later point during the mixing and incubation step 34 the temperature may be decreased. That decrease in temperature may decrease the thermal energy that is available to particulate matter and may initiate at least some particles of some sizes to be removed from solution.

Still referring to FIG. 3, methods 22 may include a purification of the combined beverage step 36. Purification of the combined beverage step 36 may include the removal of particles by gravity filtration, may involve passing the beverage solution through a filter to collect residual particles, or a combination of those operations. The filtration of a beverage at this stage may substantially remove particles that may at least in part comprise proteins that are connected through polyphenols. In step 38 of methods 22, a stabilized beverage may be packaged for consumption.

As already noted, some methods of producing a beverage may involve the combination of components in a beverage, and that combination may involve addition of the components in any order, and may involve the addition of components such that after addition they are near the desired concentration of those components in a final beverage. In other embodiments, beverages may be combined in a step-wise manner Referring to FIG. 4, methods 40 of perfotining a step-wise addition of two components are illustrated. Those methods 40 may include the addition of a first component to a tank, which may be used to hold a beverage, and may involve adding the entire portion of that first component that may be intended for use in a batch process useful for production of a beverage. In some embodiments, that first component may be a vegetable juice. In a step 44, the addition of a portion of a second component may be added, and allowed to mix with the first component. The second component may be a fruit juice, and in some embodiments may have a higher polyphenol content but lower protein content than a first component. In some embodiments, the portion of a second component that may be added during step 44 may be between about 20% and about 80% of the total amount of the second component that may be added in methods 40. Following the addition of a portion of a second component 44, the combination may be allowed to incubate at step 46 for some period of time. That period of time may be longer than the time necessary to ensure adequate mixing. In step 48, a remaining portion of a second component may be added to the tank that may be used to hold a beverage. After the addition of a portion of second component in step 44 and the addition of a remaining portion of a second component in step 48, that second component may be at substantially the same concentration as is intended in a final beverage that may be consumed. It should be noted that the description of methods 40 as involving two components is for simplicity and explanation purposes only and is not intended to be limiting. For example, one may add any number of additional components, and those additional components may be by way of nonlimiting example additives, other fruit juices, other vegetable juices, or any combination thereof. The desired concentration ratio of a first component and a second component in solution during incubation stage 46 may be a ratio that encourages a high rate of particle growth, a large particle size distribution, or a combination thereof, and may be measured by way of nonlimiting example using techniques related to turbidimetry.

In some embodiments of methods 40, the addition of a portion of a second component in step 44 may result in a concentration ratio of proteins to polyphenols that results in a larger average particle size than would result from addition of the second component in one step at its final desired concentration. In some embodiments of methods 40, the addition of a second component may result in a concentration ratio of proteins to polyphenols that produces near a particle size distribution that is a maximum. Near that maximum particle size distribution, the addition of a greater fraction of a second component during a step 44 may produce a lower average or median particle size, and the addition of a lesser fraction of a second component during a step 44 may also produce a lower average or median particle size.

As described previously, FIG. 1 illustrates a response function describing the concentration relationship between an example protein and an example polyphenol. In FIG. 1, the example protein is gliadin, and that protein has been used to model and understand how some other proteins, including members of the Hordein protein class present in beer, may interact with polyphenols: to initiate haze in a beverage. Additionally, tannic acid has been used to model how some polyphenols may interact with proteins to initiate haze in some beverages. As shown in FIG. 1, if one starts with a 400 mg/L solution of gliadin and adds tannic acid to a concentration level of about 60 mg/L, the addition of a derivative portion of tannic acid will result in an increased level of haze. In contrast, if one has added about 90 mg/L of tannic acid to that 400 mg/L solution of gliadin, the addition of additional portions of tannic acid will result in a decreased level of haze. Therefore, and by way of example only, if one desires to add 200 mg/L of tannic acid to a 400 mg/L solution of gliadin, and one wishes to increase the total amount of haze that is formed over some period, one may add about 90 mg/L of tannic acid, allow haze to form, and then add a remaining portion of tannic acid to reach the desired 200 mg/L. Using such an approach, the haze formed by step-wise addition is greater than that formed by addition of those components in a single step. As described previously, some embodiments describe the production of beverages that are rich in proteins, rich in polyphenols, and also resistant to the formation of haze. In the above example, that step-wise addition may increase haze, and that increase in haze may be because the size of particles is larger with step-wise addition than with a single step addition. In that light, one may use a filter that is designed to remove larger particle sizes and to pass other material. Such a filter may be used in a process to remove haze in a highly selective process, and may allow one to keep other species, such as other proteins, minerals, vitamins, carbohydrates, or other species, that may be desired. The use of a more selective filter, and the ability to remove haze active material without removing other materials in solution, may also increase the lifetime of the filter.

In the above example described in relation to FIG. 1, the addition of gliadin was added near its desired final concentration. The addition of tannic acid was added in a step-wise manner. The growth of particles will be dependent not only on the ratio of protein to polyphenol, but also upon the total number of proteins that are available and that may collide and interact with the pool of polyphenols present in solution. In that light, in some embodiments of methods 40, two components may be used wherein the first component is a predominant source of proteins, and a second component may be the predominant source of polyphenols. Addition of reagents in that order may maximize the time that a high proportion of proteins in the final beverage are subject to growth, and may also maximize the ratio of proteins to polyphenols during a stage in which those species interact.

While many examples in this document refer to methods of production of a beverage that is resistant to the formation of haze and to beverages produced using those methods, it is understood that those methods and beverages are described in an exemplary manner only and that other methods may be used. Additionally, other ingredients may be used, depending on the particular needs. Although the foregoing specific details describe certain embodiments, persons of ordinary skill in the art will recognize that various changes may be made in the details of these embodiments without departing from the spirit and scope of this invention as defined in the appended claims and considering the doctrine of equivalents. Therefore, it should be understood that this invention is not limited to the specific details shown and described herein.

What is claimed is:

1. A method of producing a clarified beverage that is resistant to the formation of particles that may produce haze, said method comprising:
placing a first beverage component in a tank, said first beverage component comprising one or more proteins;
adding a fining agent to said first beverage component, said fining agent facilitating the removal of at least some of said one or more proteins prior to the addition of a second beverage component to said tank;
adding said second beverage component to said tank, said second beverage component comprising one or more polyphenols;
mixing said first beverage component and said second beverage component to form a clarified beverage; and
packaging said clarified beverage.

2. The method of claim 1 wherein said first beverage component is the most concentrated source of proteins among other components in said clarified beverage.

3. The method of claim 1 wherein said first beverage component comprises a vegetable juice and said second beverage component comprises a fruit juice.

4. The method of claim 2 wherein said first beverage component comprises a vegetable juice and said second beverage component comprises a fruit juice.

5. The method of claim 4 wherein said vegetable juice comprises carrot juice and wherein said fruit juice comprises apple juice or grape juice.

6. A beverage produced using the method of claim 1.

7. A beverage produced using the method of claim 5.

8. The method of claim 1 wherein said fining agent comprises bentonite.

9. The method of claim 1 wherein said removal of at least some of said one or more proteins is perfoiuied at a first pH that is different from a pH of said clarified beverage.

10. The method of claim 9 wherein said first pH is between about 4.0 and about 4.5.

11. The method of claim 8 wherein said bentonite is added at a concentration between about 0.1 gm/l and about 5.0 gm/l.

12. The method of claim 1 wherein said fining agent comprises bentonite and polyvinylpyrolidone.

13. The method of claim 1 further comprising filtering said clarified beverage prior to packaging said clarified beverage.

14. A method of producing a clarified beverage that is resistant to the formation of particles that may produce haze, said method comprising:
placing a first beverage component in a tank, said first beverage component comprising one or more proteins;
adding an initial portion of a second beverage component to said tank, said second beverage component comprising one or more polyphenols;
mixing said first beverage component and said initial portion of said second beverage component;
adding another portion of said second beverage component to said tank after said mixing;
further mixing the contents of said tank to form a clarified beverage; and
packaging said clarified beverage.

15. The method of claim 14 further comprising adding a fining agent to said tank after said adding said initial portion of said second beverage component to said tank.

16. The method of claim 15 wherein said fining agent comprises bentonite and polyvinylpyrolidone.

17. The method of claim 14 wherein said adding said initial portion of said second beverage component results in a concentration ratio of proteins to polyphenols that yields a larger average particle size of particulate matter than would result from adding all of said initial portion and said another portion of said second beverage component at once.

18. The method of claim 14 further comprising filtering said clarified beverage prior to packaging said clarified beverage.

19. A beverage produced using the method of claim 14.

20. A beverage produced using the method of claim 18.
